(19) United States
(12) Patent Application Publication
(10) Pub. No.: US 2018/0195853 A1
(43) Pub. Date: Jul. 12, 2018

(54) OPTICAL INTERFEROMETER

(71) Applicant: HAMAMATSU PHOTONICS K.K., Hamamatsu-shi, Shizuoka (JP)

(72) Inventors: Yoshihisa WARASHINA, Hamamatsu-shi, Shizuoka (JP); Tomofumi SUZUKI, Hamamatsu-shi, Shizuoka (JP); Kohei KASAMORI, Hamamatsu-shi, Shizuoka (JP); Ryosuke OKUMURA, Hamamatsu-shi, Shizuoka (JP); Kyosuke KOTANI, Hamamatsu-shi, Shizuoka (JP)

(73) Assignee: HAMAMATSU PHOTONICS K.K., Hamamatsu-shi, Shizuoka (JP)

(21) Appl. No.: 15/741,558

(22) PCT Filed: Jul. 10, 2015
(86) PCT No.: PCT/JP2015/069949

§ 371 Date: Jan. 3, 2018

(30) Foreign Application Priority Data
Jul. 6, 2015 (JP) 2015-134967

(51) Int. Cl. G01B 9/02

(52) U.S. Cl. CPC G01B 9/02049; G01J 3/453; G01B 9/02027

(57) ABSTRACT

An optical interferometer includes a branching-combining unit, a first optical system, a second optical system, and a drive unit, which can be MEMS-based components. The branching-combining unit includes a branching surface, an incident surface, an output surface, and a combining surface on an interface between the interior and the exterior of a transparent member. The branching-combining unit, on the branching surface, partially reflects incident light and outputs as first branched light, and transmits the rest of the incident light into the interior as second branched light. The branching-combining unit, on the combining surface, outputs the first branched light to the outside, reflects the second branched light, and combines the light beams to be output to the outside as combined light.

### TECHNICAL FIELD

The present invention relates to a MEMS-based optical interferometer.

### BACKGROUND ART

Patent Documents 1 to 12 disclose inventions of the optical interferometers. Further, Patent Documents 1, 2, and 4 to 7 in these documents disclose inventions of MEMS (Micro Electro-Mechanical System)-based optical interferometers which can be minimized easily.

An optical interferometer disclosed in Patent Document 1 uses a branching-combining unit made of, for example, silicon to partially reflect incident light on one plane of the branching-combining unit, and transmit the rest of the incident light through the plane, to branch the light into first branched light and second branched light, and combine the first branched light and the second branched light and output as combined light. That is, the optical interferometer commonly uses one plane of the branching-combining unit as the branching surface for branching the incident light into the first branched light and the second branched light and the combining surface for combining the first branched light and the second branched light to form the combined light. Further, in the optical interferometer disclosed in this document, wavelength dispersion occurs when one light of the first branched light and the second branched light reciprocates in the branching-combining unit, and to eliminate the wavelength dispersion, the other light is made to reciprocate in a dispersion compensating member.

An optical interferometer disclosed in Patent Document 8 uses a branching-combining unit made of, for example, silicon to partially reflect incident light on a first principal surface of the branching-combining unit, and transmit the rest of the incident light through the surface, to branch the light into first branched light and second branched light, and combine the first branched light and the second branched light on a second principal surface of the branching-combining unit and output as combined light. That is, the optical interferometer uses different surfaces of the branching surface (first principal surface) for branching the incident light into the first branched light and the second branched light and the combining surface (second principal surface) for combining the first branched light and the second branched light to form the combined light. The optical interferometer disclosed in this document can decrease the wavelength dispersion, because each of the first branched light and the second branched light passes through the branching-combining unit only once.

### CITATION LIST

### Patent Literature

Patent Document 1: Japanese Patent Application Laid-Open Publication No. 2013-504066

Patent Document 2: Japanese Patent Publication No. 5204450

Patent Document 3: Japanese Patent Application Laid-Open Publication No. 2005-3572

Patent Document 4: Japanese Patent Application Laid-Open Publication No. 2008-102132

Patent Document 5: Japanese Patent Application Laid-Open Publication No. 2008-503732

Patent Document 6: Japanese Patent Application Laid-Open Publication No. 2010-170029

Patent Document 7: Japanese Patent Application Laid-Open Publication No. 2013-522600

Patent Document 8: Japanese Patent Application Laid-Open Publication No. H3-77029

Patent Document 9: Japanese Examined Patent Publication No. H7-23856

Patent Document 10: Japanese Patent Application Laid-Open Publication No. H7-139906

Patent Document 11: Japanese Patent Application Laid-Open Publication No. S60-11123

Patent Document 12: Japanese Patent Application Laid-Open Publication No. S61-195317

### SUMMARY OF INVENTION

### Technical Problem

Inventors of the present invention have found that the conventional optical interferometers disclosed in Patent Document 1 and the like have the following problem.

That is, the optical interferometer disclosed in Patent Document 1 shows a large light loss from branching to combining, because there are many interfaces between the branching-combining unit (e.g., silicon) and a surrounding medium (usually air). The light loss may decrease when an antireflection film is formed on a specific interface, however, as the MEMS-based optical interferometer is small, it is difficult to selectively form the antireflection film on the specific interface and decrease the light loss.

The optical interferometer disclosed in Patent Document 8 shows a small light loss from branching to combining because the number of interfaces between the branching-combining unit and a surrounding medium is lower than that of the optical interferometer disclosed in Patent Document 1. However, the interference efficiency is low in the optical interferometer disclosed in Patent Document 8.

Conventional techniques including those disclosed in other Patent Documents are not able to decrease the light loss and improve the interference efficiency in the MEMS-based optical interferometer.

The present invention has been made in order to solve the above problem, and an object thereof is to provide a MEMS-based optical interferometer capable of decreasing the light loss from branching to combining and improving the interference efficiency.

### Solution to Problem

An optical interferometer according to the present invention includes a branching-combining unit, a first optical system, a second optical system, and a drive unit, which are MEMS-based components. The branching-combining unit includes a branching surface, an incident surface, an output surface, and a combining surface on an interface between the interior and the exterior of a transparent member, the branching surface and the combining surface are provided separately, the branching surface partially reflects incident light entering from the outside and outputs as first branched light, and transmits the rest of the incident light into the interior as second branched light, the incident surface transmits the first branched light entering from the branching surface via the first optical system into the interior, the output surface outputs the second branched light reaching from the branching surface through the interior to the outside, and the combining surface outputs the first branched light reaching from the incident surface through the interior to the outside, reflects the second branched light entering from the output surface via the second optical system, and combines the first branched light and the second branched light to be output to the outside as combined light. The first optical system reflects the first branched light output from the branching surface by one or a plurality of mirrors, and directs the light to the incident surface. The second optical system reflects the second branched light output from the output surface by one or a plurality of mirrors, and directs the light to the combining surface. The drive unit moves any of the mirrors of the first optical system or the second optical system to adjust an optical path difference between the first branched light and the second branched light from the branching surface to the combining surface. Further, in the optical interferometer according to the present invention, the total number of the mirrors in the first optical system and the mirrors in the second optical system is an even number, and the optical interferometer branches a light ray at each position in a beam cross-section of the incident light on the branching surface, and then combines the light rays at a common position in a beam cross-section of the combined light on the combining surface.

### Advantageous Effects of Invention

The present invention can provide a MEMS-based optical interferometer capable of decreasing the light loss from branching to combining and improving the interference efficiency.

### BRIEF DESCRIPTION OF DRAWINGS

FIG. 1 is a diagram illustrating a configuration of an optical interferometer 2A of a first comparative example.

FIG. 2 is a diagram illustrating a configuration of an optical interferometer 2B of a second comparative example.

FIG. 3 is a diagram illustrating a configuration of an optical interferometer 1A of a first embodiment.

FIG. 4 is a diagram illustrating a configuration example of a first optical system 20 of the optical interferometer 1A of the first embodiment.

FIG. 5 is a diagram illustrating a configuration example of the first optical system 20 of the optical interferometer 1A of the first embodiment.

FIG. 6 is a diagram illustrating a configuration example of the first optical system 20 of the optical interferometer 1A of the first embodiment.

FIG. 7 is a diagram for explaining the number of mirrors included in the first optical system 20 and the second optical system 30 of the optical interferometer 1A of the first embodiment.

FIG. 8 is a diagram illustrating a configuration of an optical interferometer 1B of a second embodiment.

FIG. 9 is a diagram illustrating a configuration of an optical interferometer 1C of a third embodiment.

FIG. 10 is a diagram illustrating a configuration of an optical interferometer 1D of a fourth embodiment.

FIG. 11 is a diagram illustrating a configuration of an optical interferometer 1E of a fifth embodiment.

FIG. 12 is a diagram illustrating a configuration of an optical interferometer 1F of a sixth embodiment.

### DESCRIPTION OF EMBODIMENTS

Hereinafter, embodiments for carrying out the present invention will be described in detail with reference to the accompanying drawings. In the description of the drawings, the same or equivalent elements will be denoted by the same reference signs, without redundant description. The present invention is not limited to these examples, and the Claims, their equivalents, and all the changes within the scope are intended as would fall within the scope of the present invention.

Before describing optical interferometers of the embodiments, optical interferometers of comparative examples to be compared with the embodiments are described. An optical interferometer 2A of the first comparative example is similar to that disclosed in Patent Document 1. An optical interferometer 2B of the second comparative example is similar to that disclosed in Patent Document 8.

### FIRST COMPARATIVE EXAMPLE

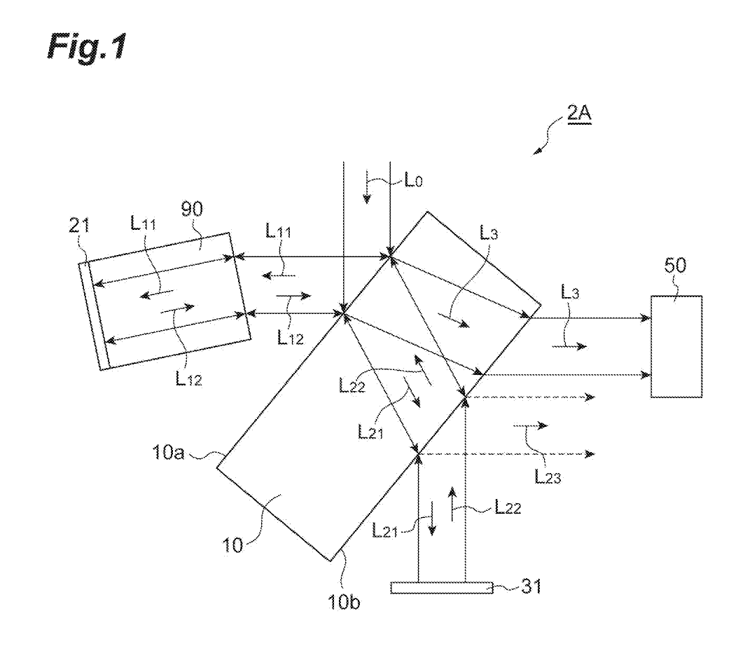

FIG. 1 is a diagram illustrating a configuration of an optical interferometer 2A of a first comparative example. The optical interferometer 2A includes a branching-combining unit 10, a mirror 21, a mirror 31, and a dispersion compensating member 90, which are MEMS-based components.

The branching-combining unit 10 is made of, for example, silicon and has a first principal surface 10a and a second principal surface 10b which are parallel to each other. Incident light L₀ that enters from the outside to the first principal surface 10a is partially reflected as first branched light L₁₁, and the rest of the incident light transmits into the interior of the branching-combining unit 10 as second branched light L₂₁.

The first branched light L₁₁ from the first principal surface 10a passes through the interior of the dispersion compensating member 90 and is reflected by the mirror 21. The first branched light L₁₂ reflected by the mirror 21 passes through the interior of the dispersion compensating member 90 again, enters the first principal surface 10a, and transmits into the interior of the branching-combining unit 10.

The second branched light L₂₁ from the first principal surface 10a passes through the interior of the branching-combining unit 10, transmits through the second principal surface 10b to be output to the outside, and is reflected by the mirror 31. The second branched light L₂₂ reflected by the mirror 31 enters the second principal surface 10b, transmits into the interior of the branching-combining unit 10, passes through the interior of the branching-combining unit 10 again, and is reflected by the first principal surface 10a.

The first branched light L₁₂ transmitted into the interior of the branching-combining unit 10 on the first principal surface 10a and the second branched light L₂₂ reflected on the first principal surface 10a are combined to form combined light L₃. The combined light L₃ passes through the interior of the branching-combining unit 10, and transmits through the second principal surface 10b to be output to the outside. The combined light L₃ output to the outside is detected by a detection unit 50.

In the optical interferometer 2A, the first principal surface 10a of the branching-combining unit 10 is used as both the branching surface for branching the incident light L₀ into the first branched light L₁₁ and the second branched light L₂₁, and the combining surface for combining the first branched light L₁₂ and the second branched light L₂₂ into the combined light L₃.

For example, the position of the mirror 21 is fixed and the mirror 31 is movable by a drive unit along the incident direction of the second branched light L₂₁. The drive unit can also be configured by a MEMS-based component. Since the mirror 31 is movable, the optical path difference between the first branched light and the second branched light is adjustable.

In the optical interferometer 2A, the branching-combining unit 10 and the dispersion compensating member 90 are made of the same material (e.g., silicon). Further, the optical path length of a section where the first branched light L₁₁, L₁₂ reciprocates in the dispersion compensating member 90 is set to be equal to the optical path length of a section where the second branched light L₂₁, L₂₂ reciprocates in the branching-combining unit 10. This eliminates the problem of wavelength dispersion and decreases wavelength dependency of the optical path difference between the first branched light and the second branched light.

The optical interferometer 2A shows a problem described below because of many interfaces. Here, the branching-combining unit 10 and the dispersion compensating member 90 are made of silicon (refractive index 3.5), a surrounding medium is air (refractive index 1.0), and an incident angle of the incident light L₀ to the first principal surface 10a is 45 degrees. The reflectance of light at the interface of silicon and air is 30%, and the transmittance is 70%. Here, precisely, the reflectance and the transmittance vary for S-waves and P-waves, however, incoherent light is expected to have polarization directions distributed randomly, so that the average value is taken to set the reflectance of 30% and the transmittance of 70%. Further, the mirrors 21 and 31 are assumed to have the reflectance of light of 100%.

A ratio R₁ of the incident light L₀ that reaches the detection unit 50 via the first branched light is calculated as a product of the reflectance (0.3) on the first principal surface 10a, the transmittance (0.7) from the air to the dispersion compensating member 90, the reflectance (1.0) on the mirror 21, the transmittance (0.7) from the dispersion compensating member 90 to the air, the transmittance (0.7) from the exterior to the interior on the first principal surface 10a, and the transmittance (0.7) from the interior to the exterior on the second principal surface 10b, and thus, the ratio is 7.2%.

A ratio R₂ of the incident light L₀ that reaches the detection unit 50 via the second branched light is calculated as a product of the transmittance (0.7) from the exterior to the interior on the first principal surface 10a, the transmittance (0.7) from the interior to the exterior on the second principal surface 10b, the reflectance (1.0) on the mirror 31, the transmittance (0.7) from the exterior to the interior on the second principal surface 10b, the reflectance (0.3) on the first principal surface 10a, and the transmittance (0.7) from the interior to the exterior on the second principal surface 10b, and thus, the ratio is 7.2%.

An interference intensity peak Iₚₚ of the combined light L₃ is 14.4% by the formula represented by Iₚₚ=2√(R₁·R₂).

Here, the reflection of light on the interface between the dispersion compensating member 90 and the air and the reflection of light on the second principal surface 10b are entirely the excessive loss. When an antireflection film is formed on these surfaces, the interference intensity peak Iₚₚ of the combined light L₃ is 42%. That is, the excessive loss of 27.6% occurs.

However, it is difficult to form such an antireflection film selectively on the specific interface, as the size of the MEMS-based optical interferometer 2A is small. The excessive loss is inevitable as long as the MEMS-based optical interferometer is used.

Further, the optical interferometer 2A has another problem, because the second branched light L₂₂ entering the second principal surface 10b is partially reflected. As illustrated in FIG. 1, the second branched light L₂₃, which is part of the second branched light L₂₂ entering the second principal surface 10b from the mirror 31 and reflected by the second principal surface 10b, propagates in the same direction as the combined light L₃ which is output to the outside from the second principal surface 10b. Actually, the combined light L₃ and the second branched light L₂₂ each have a certain beam width. If the detection unit 50 partially detects the second branched light L₂₃ reflected by the second principal surface 10b, the detection accuracy of the detection unit 50 to detect the interference intensity of the combined light L₃ decreases. In particular, when the light is not collimated light but diverging light, the detection accuracy of the interference intensity of the combined light L₃ by the detection unit 50 further decreases.

To prevent such decrease of the detection accuracy of the interference intensity, it is necessary to increase a distance between the first principal surface 10a and the second principal surface 10b of the branching-combining unit 10 to sufficiently separate the optical path of the second branched light L₂₃ which is reflected by the second principal surface 10b from the optical path of the combined light L₃. This, however, increases the optical path length of the incident light L₀ when it is branched to make the combined light L₃ and reaches the detection unit 50, and thus, a loss is generated.

### SECOND COMPARATIVE EXAMPLE

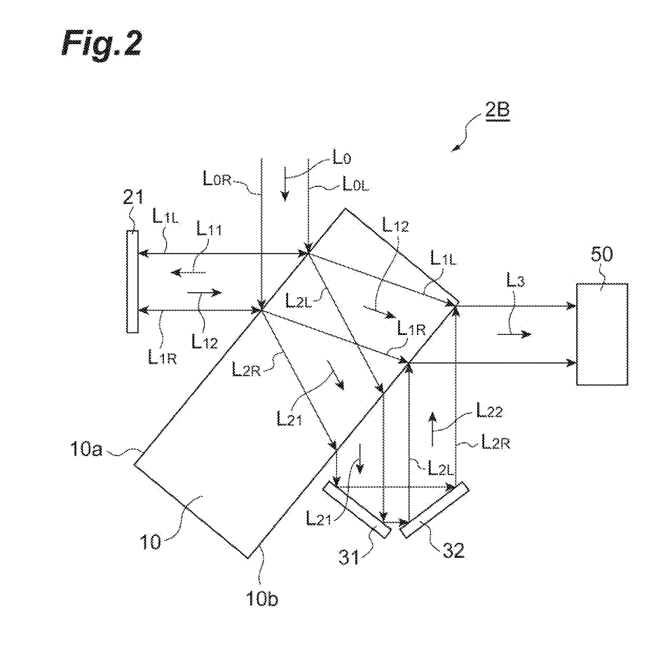

FIG. 2 is a diagram illustrating a configuration of an optical interferometer 2B of a second comparative example. The optical interferometer 2B includes a branching-combining unit 10, a mirror 21, a mirror 31, and a mirror 32.

The branching-combining unit 10 is made of, for example, silicon and has a first principal surface 10a and a second principal surface 10b which are parallel to each other. Incident light L₀ that enters from the outside to the first principal surface 10a is partially reflected as first branched light L₁₁, and the rest of the incident light transmits into the interior of the branching-combining unit 10 as second branched light L₂₁.

The first branched light L₁₁ from the first principal surface 10a is reflected by the mirror 21. The first branched light L₁₂ reflected by the mirror 21 enters the first principal surface 10a, transmits into the interior of the branching-combining unit 10, passes through the interior of the branching-combining unit 10, and transmits through the second principal surface 10b to be output to the outside.

The second branched light L₂₁ from the first principal surface 10a passes through the interior of the branching-combining unit 10, transmits through the second principal surface 10b to be output to the outside, is reflected by the mirror 31, and is reflected again by the mirror 32. The second branched light L₂₂ reflected by the mirrors 31 and 32 enters the second principal surface 10b and is reflected.

The first branched light L₁₂ output to the outside on the second principal surface 10b and the second branched light L₂₂ reflected on the second principal surface 10b are combined to form combined light L₃. The combined light L₃ is detected by a detection unit 50.

The optical interferometer 2B uses separate surfaces for the branching surface (first principal surface 10a) to branch the incident light L₀ into the first branched light L₁₁ and the second branched light L₂₁ and for the combining surface (second principal surface 10b) to combine the first branched light L₁₂ and the second branched light L₂₂ to form the combined light L₃.

For example, the position of the mirror 21 is fixed, and the mirrors 31 and 32 are movable by a drive unit along the incident direction of the second branched light L₂₁. The drive unit can also be configured by a MEMS-based component. Since the mirrors 31 and 32 are movable, the optical path difference between the first branched light and the second branched light is adjustable.

The optical interferometer 2B of the second comparative example allows the first branched light and the second branched light to pass through the interior of the branching-combining unit 10 only once, thus preventing the problem of wavelength dispersion without using the dispersion compensating member 90, which is required in the optical interferometer 2A of the first comparative example.

The optical interferometer 2B of the second comparative example gives a smaller excessive loss due to the interfaces, as there are less interfaces between the branching-combining unit 10 and the surrounding medium, when compared to the optical interferometer 2A of the first comparative example. However, the optical interferometer 2B has a problem described below.

In the optical interferometer 2B, the branching surface (first principal surface 10a) is different from the combining surface (second principal surface 10b), so that the first branched light is reflected by the single mirror 21 and the second branched light is reflected by the two mirrors 31 and 32 to combine the first branched light and the second branched light on the combining surface. By reflecting the second branched light by the two mirrors 31 and 32, the reflecting position (combining position) of the second branched light on the second principal surface 10b differs from the output position of the second branched light from the interior to the exterior on the second principal surface 10b, and further, coincides with the output position of the first branched light from the interior to the exterior on the second principal surface 10b.

Here, consider light rays L_{0R} and L_{0L} that pass through two different positions in the beam cross-section of the incident light L₀. The two light rays L_{0R} and L_{0L} of the incident light L₀ propagate through different paths within a plane that is parallel to both the normal line of the first principal surface 10a and the incident direction of the incident light L₀. Assume that, in the first branched light L₁₁, L₁₂, a light ray L_{1R} is derived from one light ray L_{0R} of the incident light L₀, and a light ray L_{1L} is derived from the other light ray L_{0L} of the incident light L₀. Assume that, in the second branched light L₂₁, L₂₂, a light ray L_{2R} is derived from one light ray L_{0R} of the incident light L₀, and a light ray L_{2L} is derived from the other light ray L_{0L} of the incident light L₀.

At this time, on the combining surface (second principal surface 10b), the light ray L_{1R} of the first branched light derived from the one light ray L_{0R} of the incident light L₀ is combined with the light ray L_{2L} of the second branched light derived from the other light ray L_{0L} of the incident light L₀. Further, the light ray L_{1L} of the first branched light derived from the other light ray L_{0L} of the incident light L₀ is combined with the light ray L_{2R} of the second branched light derived from the one light ray L_{0R} of the incident light L₀.

That is, when the light rays of the first branched light and the second branched light reaching each position of the combining surface (second principal surface 10b) are derived from different light rays of the incident light, these light rays do not form normal interference light even though the light rays are combined to form the combined light. On the other hand, when the incident light L₀ is given as a light ray formed by expanding and collimating a single light ray of, for example, a point light source, the light rays of the first branched light and the second branched light reaching each position may interfere with each other, however, the quality of the interference signal may decrease, because the optical path difference is generated by a spatial distance between the light ray L_{1R} and the light ray L_{1L} in the beam cross-section of the first branched light.

Normally, the optical interferometer is expected to have the same optical path difference between the first branched light and the second branched light that reach the respective positions as the optical path difference adjusted by the movement of mirrors. However, in the beam width range provided in the optical interferometer 2B, the optical path difference changes between the beam which is closer to the center and the beam which is closer to the edge portion, whereby an observed interference signal is averaged and weakened as a whole.

An optical interferometer used in FTIR (Fourier Transform Infrared Spectroscopy) uses light having a large beam diameter in order to increase a parallel nature of the propagating light. As a result, the light includes many beams having different optical path differences, and thus the optical interferometer 2B that uses the combined light beams at different positions as the interference signal has an intrinsic problem with respect to interference.

### First Embodiment

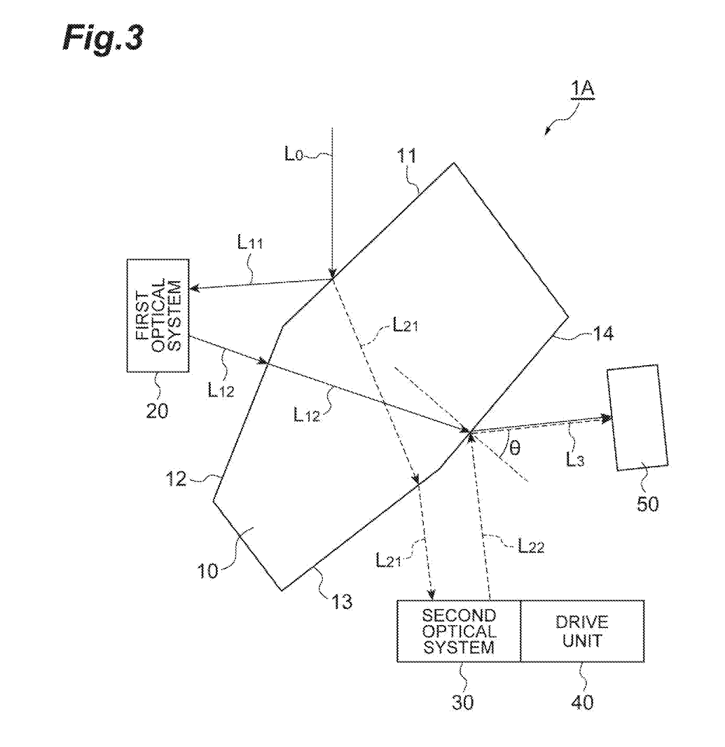

FIG. 3 is a diagram illustrating a configuration of an optical interferometer 1A of a first embodiment. The configuration of the optical interferometer 1A is generalized for explanation. The optical interferometer 1A includes a branching-combining unit 10, a first optical system 20, a second optical system 30, and a drive unit 40, which can be configured by MEMS-based components.

The branching-combining unit 10 is made of a transparent member of a semiconductor, such as silicon, and has a branching surface 11, an incident surface 12, an output surface 13, and a combining surface 14 on interfaces between the interior and the exterior of the transparent member.

The branching-combining unit 10, on the branching surface 11, partially reflects incident light L₀ that enters from the outside and outputs as first branched light L₁₁, and transmits the rest of the incident light into the interior as second branched light L₂₁. The branching-combining unit 10, on the incident surface 12, transmits the first branched light L₁₂ that enters from the branching surface 11 via the first optical system 20 into the interior.

The branching-combining unit 10, on the output surface 13, outputs the second branched light L₂₁ that reaches from the branching surface 11 through the interior to the outside. The branching-combining unit 10, on the combining surface 14, outputs the first branched light L₁₂ that reaches from the incident surface 12 through the interior to the outside, reflects the second branched light L₂₂ that enters from the output surface 13 via the second optical system 30, and combines the first branched light L₁₂ and the second branched light L₂₂ to be output to the outside as combined light L₃.

The first optical system 20 reflects the first branched light L₁₁ output from the branching surface 11 by one or a plurality of mirrors, and directs the reflected first branched light L₁₂ to the incident surface 12. The second optical system 30 reflects the second branched light L₂₁ output from the output surface 13 by one or a plurality of mirrors, and directs the reflected second branched light L₂₂ to the combining surface 14. The drive unit 40 moves any of the mirrors of the first optical system 20 or the second optical system 30 to adjust an optical path difference between the first branched light and the second branched light from the branching surface 11 to the combining surface 14.

The incident light L₀ that enters the branching surface 11 from the outside is partially reflected as the first branched light L₁₁, and the rest of the incident light transmits into the interior of the branching-combining unit 10 as the second branched light L₂₁.

The first branched light L₁₁ from the branching surface 11 is reflected by one or a plurality of mirrors of the first optical system 20. The reflected first branched light L₁₂ enters the incident surface 12, transmits into the interior of the branching-combining unit 10, passes through the interior of the branching-combining unit 10, and transmits through the combining surface 14 to be output to the outside.

The second branched light L₂₁ from the branching surface 11 passes through the interior of the branching-combining unit 10, transmits through the output surface 13 to be output to the outside, and is reflected by one or a plurality of mirrors of the second optical system 30. The reflected second branched light L₂₂ enters the combining surface 14 and is reflected.

The first branched light L₁₂ output to the outside on the combining surface 14 and the second branched light L₂₂ reflected on the combining surface 14 are combined to form combined light L₃. The combined light L₃ is detected by a detection unit 50.

Assume that a refractive index of the branching-combining unit 10 is n₁ and a refractive index of a surrounding medium is n₂. The reflectance R of light on each surface of the branching-combining unit 10 is represented by the following formula (1), and the transmittance T of light is represented by the following formula (2). Here, precisely, the reflectance changes depending on the incident angle and the polarization direction of light, however, when the incident light is from an incoherent light source, the polarization directions are randomly distributed, and when the incident angle is expected to be equal to or smaller than Brewster's angle, total reflectance and transmittance are approximately equal to the formula (1) and the formula (2). When the branching-combining unit 10 is made of silicon (refractive index 3.5) and the surrounding medium is air (refractive index 1.0), the reflectance R of light is 30% and the transmittance T is 70% on each surface of the branching-combining unit 10. A branching ratio of the branching surface 11 as a beam splitter is 3:7. Assume that the reflectance of light in the first optical system 20 and the second optical system 30 is 100%.

R={(n₁−n₂)/(n₁+n₂)}² (1)

T=1−R (2)

A ratio R₁ of the incident light L₀ that reaches the detection unit 50 via the first branched light is calculated as, a product of the reflectance (0.3) on the branching surface 11, the reflectance (1.0) in the first optical system 20, the transmittance (0.7) on the incident surface 12, and the transmittance (0.7) on the combining surface 14, and thus, the ratio is 14.7%.

A ratio R₂ of the incident light L₀ that reaches the detection unit 50 via the second branched light is calculated as a product of the transmittance (0.7) on the branching surface 11, the transmittance (0.7) on the output surface 13, the reflectance (1.0) in the second optical system 30, and the reflectance (0.3) on the combining surface 14, and thus, the ratio is 14.7%.

An interference intensity peak Iₚₚ of the combined light L₃ is 29.4% by the formula represented by Iₚₚ=2√(R₁·R₂). The interference intensity peak of the combined light L₃ of the present embodiment is larger than that of the first comparative example. An excessive loss is only the reflections of light on the incident surface 12 and the output surface 13.

The present embodiment can decrease the optical path length to reach the detection unit 50, when the thickness of the branching-combining unit 10 is about the same as the thickness of that in the first comparative example. Further, unlike the first comparative example, the present embodiment does not require an increase in thickness of the branching-combining unit 10 to consider the beam expansion of the light. This is because the second branched light L₂₂ reflected on the combining surface 14 is combined with the first branched light L₁₂ to form the combined light L₃ and not to fonn stray light.

The directions of the branching surface 11, the incident surface 12, the output surface 13, and the combining surface 14 of the branching-combining unit 10 and the light incident positions and the incident angles on the respective surfaces are set appropriately according to the refractive indexes of the branching-combining unit 10 and the surrounding medium, so that the first branched light and the second branched light are combined coaxially on the combining surface 14 and output to the outside as the combined light L₃ at the same output angle θ.

The branching surface 11 and the combining surface 14 are provided separately. The branching surface 11 and the incident surface 12 may not be parallel to each other, may be parallel to each other, and may be provided on a common plane. An incident region of the incident light L₀ on the branching surface 11 and an incident region of the first branched light L₁₂ on the incident surface 12 may be different or may coincide with each other partially or entirely. The output surface 13 and the combining surface 14 may not be parallel to each other, may be parallel to each other, and may be provided on a common plane. An output region of the second branched light L₂₁ on the output surface 13 and an output region of the combined light L₃ on the combining surface 14 may be different or may coincide with each other partially or entirely.

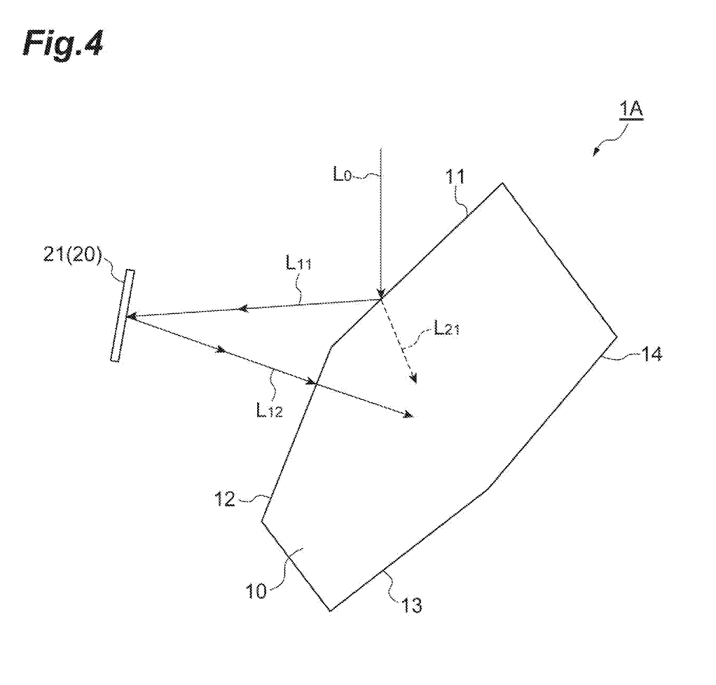

FIG. 4 to FIG. 6 are diagrams illustrating configuration examples of the first optical system 20 of the optical interferometer 1A of the first embodiment. The following description of the first optical system 20 can be similarly applied to the second optical system 30.

In the configuration example illustrated in FIG. 4, the first optical system 20 includes a single mirror 21. The mirror 21 reflects the first combined light L₁₁, which is reflected by the branching surface 11 of the branching-combining unit 10 and output in a predetermined direction (hereinafter referred to as “output direction”), and then directs the reflected first branched light L₁₂ to the incident surface 12 of the branching-combining unit 10 in a predetermined direction (hereinafter referred to as “incident direction”).

This configuration example can be used when the output direction intersects with the incident direction, and the mirror 21 reflects the first branched light at the position of the intersection point. When, however, the output direction and the incident direction intersect with each other, and the position of the intersection point is located far from the branching-combining unit 10, the optical path length of the first branched light is long and a loss is generated due to the beam expansion and the like of the first branched light, and therefore, the next configuration example will be preferable.

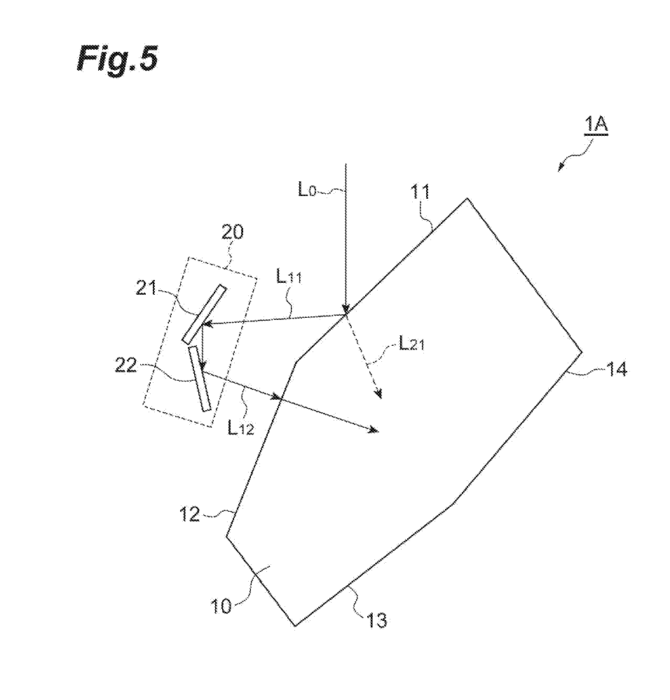

In the configuration example illustrated in FIG. 5, the first optical system 20 includes two mirrors 21 and 22. The first branched light L₁₁, which is reflected by the branching surface 11 of the branching-combining unit 10 and output in the predetermined direction (output direction), is reflected sequentially by the mirrors 21 and 22. The reflected first branched light L₁₂ enters the incident surface 12 of the branching-combining unit 10 in the predetermined direction (incident direction).

In this configuration example, the reflection surfaces of the mirror 21 and the mirror 22 are perpendicular to each other, when the output direction and the incident direction of the first branched light are parallel to each other. By moving the mirrors 21 and 22 as a unit by the drive unit in the direction parallel to the incident direction and the output direction, the optical path length of the first branched light can be adjusted without changing the incident position of the first branched light L₁₂ on the incident surface 12.

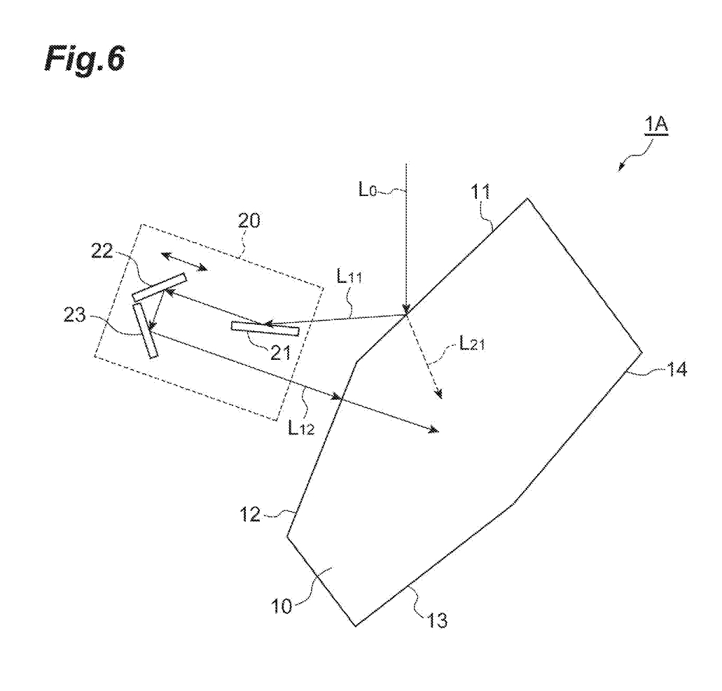

In the configuration example illustrated in FIG. 6, the first optical system 20 includes three mirrors 21 to 23. The first branched light L₁₁, which is reflected by the branching surface 11 of the branching-combining unit 10 and output in the predetermined direction (output direction), is reflected sequentially by the mirrors 21 to 23. The reflected first branched light L₁₂ enters the incident surface 12 of the branching-combining unit 10 in the predetermined direction (incident direction).

In this configuration example, the reflection surfaces of the mirror 22 and the mirror 23 are perpendicular to each other. The optical path of the first branched light from the mirror 21 to the mirror 22 is parallel to the optical path of the first branched light from the mirror 23 to the incident surface 12. Therefore, by moving the mirrors 22 and 23 as a unit by the drive unit in the direction (incident direction) indicated by a double-headed arrow in FIG. 6, the optical path length of the first branched light can be adjusted without changing the incident position of the first branched light L₁₂ on the incident surface 12.

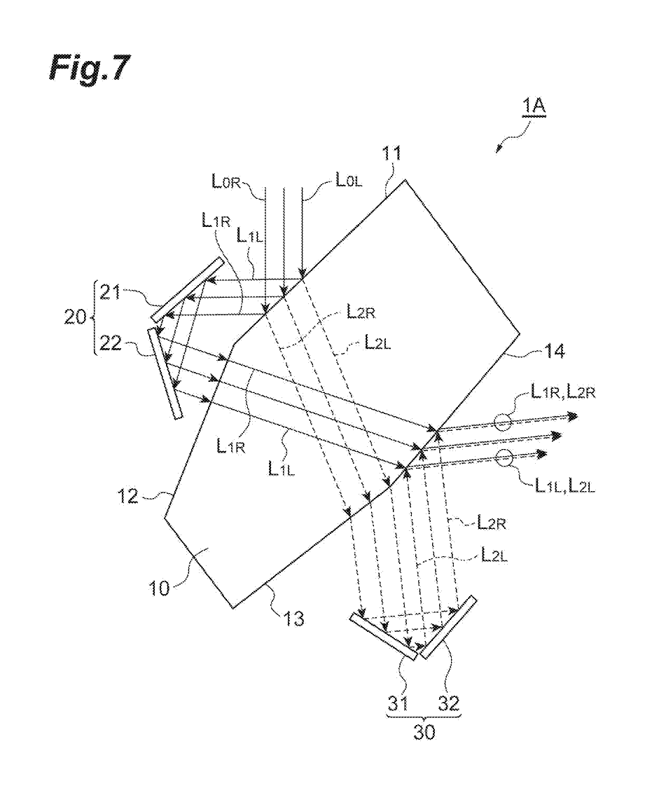

In the following, the number of mirrors included in the first optical system 20 and the second optical system 30 is described. FIG. 7 is a diagram for explaining the number of mirrors included in the first optical system 20 and the second optical system 30 of the optical interferometer 1A of the first embodiment. In FIG. 7, the first optical system 20 includes two mirrors 21 and 22, and the second optical system 30 includes two mirrors 31 and 32.

Further, in FIG. 7, consider light rays L_{0R} and L_{0L} that pass through two different positions in the beam cross-section of the incident light L₀. The two light rays L_{0R} and L_{0L} of the incident light L₀ propagate through different paths within a plane that is parallel to both the normal line of the branching surface 11 and the incident direction of the incident light L₀. Assume that, in the first branched light L₁₁, L₁₂, a light ray L_{1R} is derived from one light ray L_{0R} of the incident light L₀, and a light ray L_{1L} is derived from the other light ray L_{0L} of the incident light L₀. Assume that, in the second branched light L₂₁, L₂₂, a light ray L_{2R} is derived from one light ray L_{0R} of the incident light L₀, and a light ray L_{2L} is derived from the other light ray L_{0L} of the incident light L₀.

Generally, the positions of left and right light rays switch every time the light is reflected by the mirror. In the configuration of FIG. 7, the first branched light is reflected twice in the first optical system 20, and the second branched light is reflected twice in the second optical system 30. As a result, the light rays of the first branched light and the second branched light that reach each position of the combining surface 14 are derived from the same light ray in the incident light, so that the light rays can interfere with each other efficiently.

Generally, when the total number of the mirrors in the first optical system 20 and the mirrors in the second optical systems 30 is an even number, the light ray at each position in the beam cross-section of the incident light L₀ is branched on the branching surface 11, and then the light rays are combined at a common position in the beam cross-section of the combined light L₃ on the combining surface 14, and thus, the efficient interference light can be obtained. In contrast, the interference efficiency decreases when the total number of the mirrors in the first optical system 20 and the mirrors in the second optical systems 30 is an odd number.

A relationship of the branching surface 11, the incident surface 12, the output surface 13, and the combining surface 14 of the branching-combining unit 10 is described below. Generally, when the branching-combining unit 10 is made with a material such as a semiconductor material, the optical path length (=geometric length multiplied by refractive index) of light when the light passes through the branching-combining unit 10 varies depending on the wavelength, because the refractive index of the material varies depending on the wavelength, and thus, wavelength dispersion occurs.

The wavelength dispersion can be compensated for over the entire wavelengths by equalizing propagating distances of the first branched light and the second branched light through the interior of the branching-combining unit 10. Further, by considering that each of the first branched light and the second branched light has a beam width, it is desirable to equalize the propagating distances of the light rays at respective positions in the beam cross-section of the first branched light and the second combined light through the interior of the branching-combining unit 10. That is, it is desirable that the branching surface 11 and the output surface 13 are parallel to each other, and the incident surface 12 and the combining surface 14 are parallel to each other. It is also desirable that a distance between the branching surface 11 and the output surface 13 is equal to a distance between the incident surface 12 and the combining surface 14.

Further, it is desirable that the optical path length of the first branched light from the branching surface 11 to the incident surface 12 via the first optical system 20 coincides with the optical path length of the second branched light from the output surface 13 to the combining surface 14 via the second optical system 30 with respect to the light rays at respective positions in the beam cross-section. That is, it is desirable that the branching surface 11 and the incident surface 12 are parallel to each other, and provided on a common plane. It is desirable that the output surface 13 and the combining surface 14 are parallel to each other, and provided on a common plane. Further, it is desirable that each of the first optical system 20 and the second optical system 30 includes two mirrors disposed such that reflection surfaces of the minors are arranged perpendicular to each other.

Embodiments described below have desirable configurations in consideration of the above matters.

### Second Embodiment

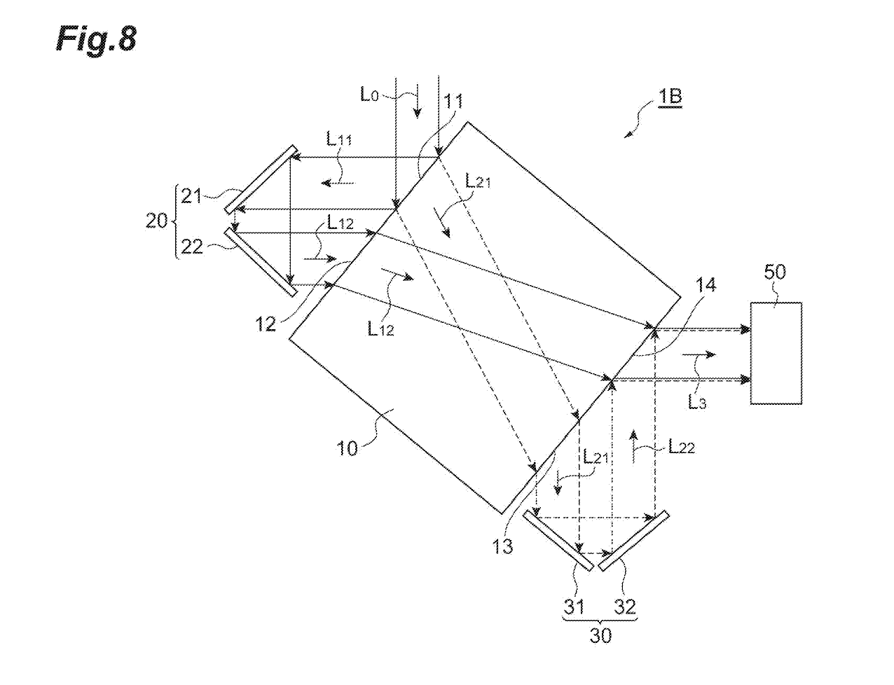

FIG. 8 is a diagram illustrating a configuration of an optical interferometer 1B of a second embodiment. In the optical interferometer 1B, a branching surface 11 and an incident surface 12 are provided on a common plane but at different regions. An output surface 13 and a combining surface 14 are provided on a common plane but at different regions. The branching surface 11 and the incident surface 12, and the output surface 13 and the combining surface 14 are parallel to each other. The present embodiment can completely compensate for the wavelength dispersion.

A first optical system 20 includes two mirrors 21 and 22 disposed such that the reflection surfaces of the mirrors are perpendicular to each other. The first optical system 20 reflects first branched light L₁₁, which is reflected by the branching surface 11, by the mirrors 21 and 22 sequentially, and directs the light as first branched light L₁₂ to the incident surface 12. The first branched light L₁₂ entering the incident surface 12 is parallel to the first branched light L₁₁ reflected by the branching surface 11 and propagates in the opposite direction, and enters a position on the incident surface 12 which is different from the reflecting position on the branching surface 11.

A second optical system 30 includes two mirrors 31 and 32 disposed such that the reflection surfaces of the mirrors are perpendicular to each other. The second optical system 30 reflects second branched light L₂₁, which is output to the outside from the output surface 13, by the mirrors 31 and 32 sequentially, and directs the light as second branched light L₂₂ to the combining surface 14. The second branched light L₂₂ entering the combining surface 14 is parallel to the second branched light L₂₁ output from the output surface 13 and propagates in the opposite direction, and enters a position on the combining surface 14 which is different from the output position on the output surface 13.

By driving both or one of the first optical system 20 and the second optical system 30 by the drive unit 40, the optical path difference between the first branched light and the second branched light can be adjusted. For example, to adjust the optical path length of the first branched light, the two mirrors 21 and 22 in the first optical system 20 are moved as a unit in the direction parallel to the reflecting direction of the first branched light L₁₁ from the branching surface 11.

### Third Embodiment

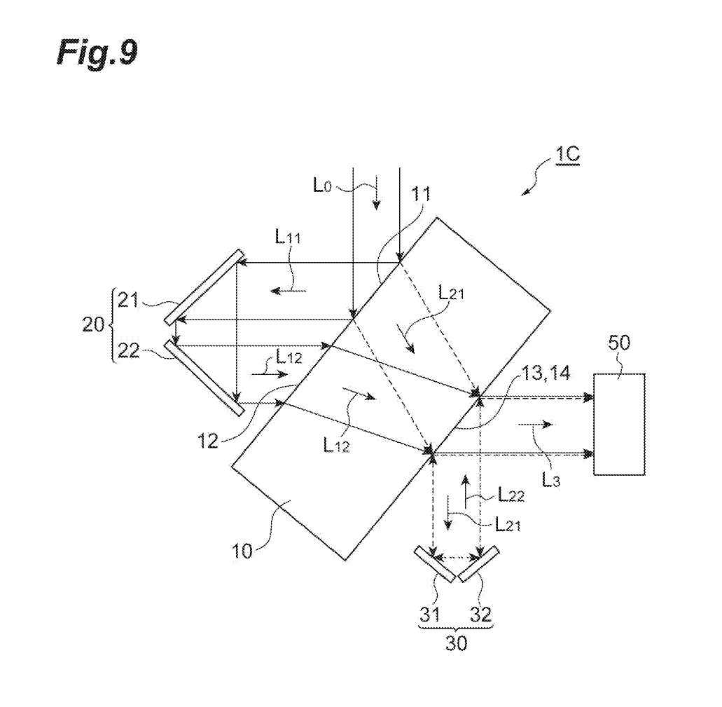

FIG. 9 is a diagram illustrating a configuration of an optical interferometer 1C of a third embodiment. The optical interferometer 1C of the third embodiment illustrated in FIG. 9 differs from the configuration of the optical interferometer 1B of the second embodiment illustrated in FIG. 8 in that the output surface 13 and the combining surface 14 are a common surface. This configuration is achieved by appropriately setting the thickness of the branching-combining unit 10.

An output region of the second branched light L₂₁ on the output surface 13 and an output region of the combined light L₃ on the combining surface 14 coincide with each other. The second branched light L₂₁ propagating from the branching-combining unit 10 to the mirror 31 propagates in the opposite direction to the second branched light L₂₂ propagating from the mirror 32 to the branching-combining unit 10, and further, both beams are overlapped.

As compared to the configuration of the optical interferometer 1B of the second embodiment illustrated in FIG. 8, the optical interferometer 1C of the third embodiment illustrated in FIG. 9 can decrease the optical path length of each of the first branched light and the second branched light, whereby beam expansion that cannot be ignored in practice can be minimized.

Here, although the second branched light L₂₁ is partially reflected by the output surface 13 and propagates in the direction opposite to the propagating path of the first branched light, such light does not turn into stray light for the combined light L₃ and causes no influence.

### Fourth Embodiment

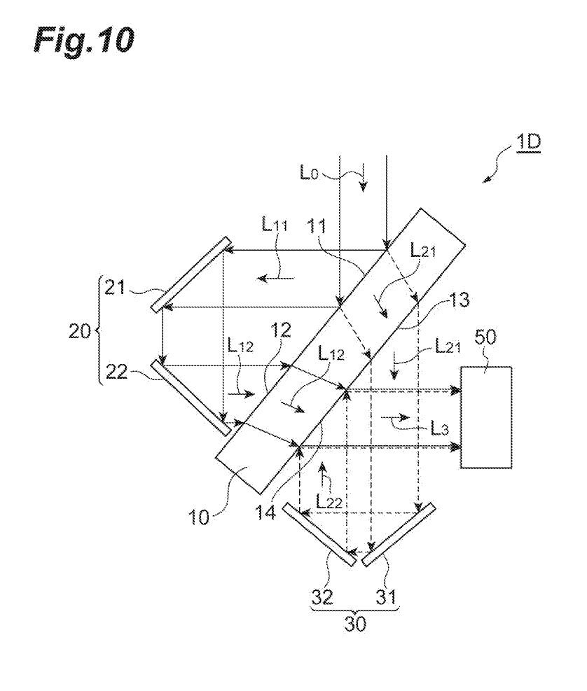

FIG. 10 is a diagram illustrating a configuration of an optical interferometer 1D of a fourth embodiment. The optical interferometer 1D of the fourth embodiment illustrated in FIG. 10 differs from the configuration of the optical interferometer 1B of the second embodiment illustrated in FIG. 8 in that the arrangement of the output surface 13 and the combining surface 14 is reversed in the branching-combining unit 10. This configuration is achieved by decreasing the thickness of the branching-combining unit 10.

In the present embodiment, a Fabry-Perot effect by both principal surfaces of the branching-combining unit 10 appears when the thickness of branching-combining unit 10 is excessively decreased, and therefore, the thickness of the branching-combining unit 10 is set to an extent such that the Fabry-Perot effect can be prevented. Preferably, the second branched light reflected by the output surface 13 does not overlap the second branched light on the branching surface 11. In this case, the first branched light reflected by the combining surface 14 does not overlap the first branched light on the incident surface 12.

Further, in this embodiment, it is necessary to set such that the second branched light (hereinafter referred to as “reflected second branched light”) which is reflected by the output surface 13 and transmits through the branching surface 11 does not enter the mirror 21, or the optical path length of the reflected second branched light is equal to or larger than the movable distance of the mirrors 21 and 22. When even a partial beam of the reflected second branched light enters the mirror 21, the beam is combined with the combined light L₃. At this time, when there is an optical path difference equal to or larger than the movable distance of the mirrors 21 and 22 between the reflected second branched light and the usual combined light L₃, an interference peak by the reflected second branched light occurs outside the movable distance of the mirrors 21 and 22, and does not affect the interference observation. Needless to say, no problem occurs when the reflected second branched light does not enter the mirror 21.

### Fifth Embodiment

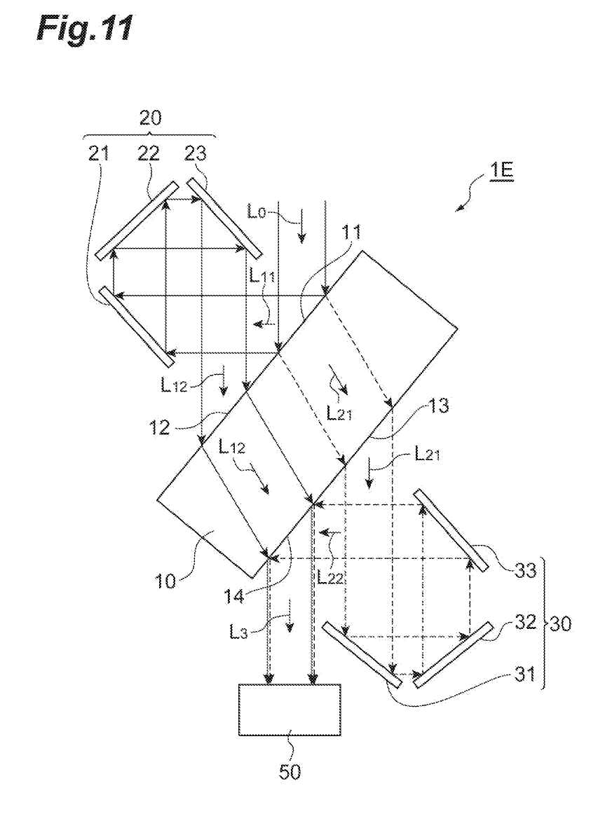

FIG. 11 is a diagram illustrating a configuration of an optical interferometer 1E of a fifth embodiment. The optical interferometer lE of the fourth embodiment illustrated in FIG. 11 differs from the configuration of the optical interferometer 1D of the second embodiment illustrated in FIG. 10 in that the first optical system 20 includes three mirrors 21 to 23 and the second optical system 30 includes three mirrors 31 to 33.

In the first optical system 20, the reflection surface of the mirror 21 and the reflection surface of the mirror 22 are perpendicular to each other, and the reflection surface of the mirror 22 and the reflection surface of the mirror 23 are also perpendicular to each other. The first optical system 20 reflects the first branched light L₁₁ reflected by the branching surface 11 by the mirrors 21 to 23 sequentially. In the second optical system 30, the reflection surface of the mirror 31 and the reflection surface of the mirror 32 are perpendicular to each other, and the reflection surface of the mirror 32 and the reflection surface of the mirror 33 are also perpendicular to each other. The second optical system 30 reflects the second branched light L₂₁ output from the output surface 13 by the mirrors 31 to 33 sequentially. In the branching-combining unit 10, the first branched light L₁₂ and the second branched light L₂₁ propagate in parallel to each other. The combined light L₃ and the incident light L₀ propagate in parallel to each other.

### Sixth Embodiment

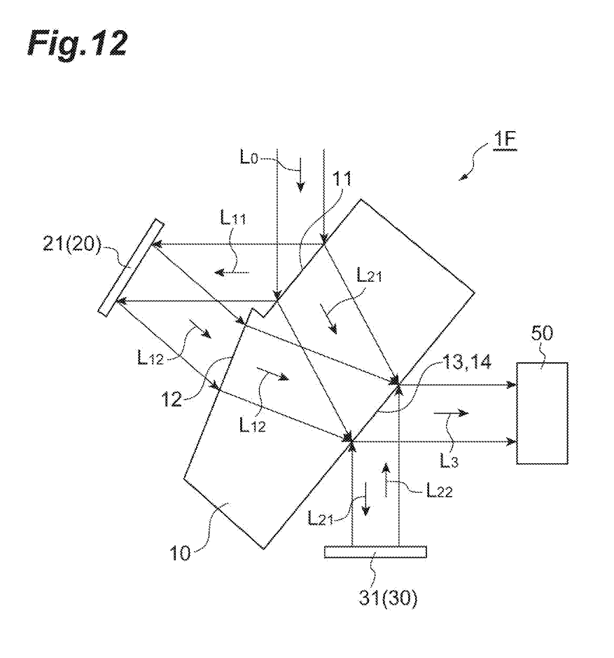

FIG. 12 is a diagram illustrating a configuration of an optical interferometer 1F of a sixth embodiment. In the optical interferometer 1F, the first optical system 20 includes a single mirror 21, the second optical system 30 includes a single mirror 31, the branching surface 11 and the incident surface 12 are not parallel to each other, and the output surface 13 and the combining surface 14 are a common surface.

In the present embodiment, each of the first optical system 20 and the second optical system 30 includes a single mirror, so that the optical path length of each of the first branched light and the second branched light can be shortened. Therefore, the optical interferometer can be smaller in the case where the expansion of the light beam cannot be ignored, so that the light loss can be decreased.

The optical interferometer according to the present invention is not limited to the embodiments and configuration examples described above, and various modifications can be made. For example, another embodiment of the optical interferometer may reverse the light propagating direction as compared to each of the above embodiments, and even in this case, can operate as an optical interferometer.

An optical interferometer of the above-described embodiment includes a MEMS-based branching-combining unit, a first optical system, a second optical system, and a drive unit. The branching-combining unit includes a branching surface, an incident surface, an output surface, and a combining surface on interfaces between the interior and the exterior of a transparent member, the branching surface and the combining surface are provided separately, the branching surface partially reflects incident light entering from the outside and outputs as first branched light, and transmits the rest of the incident light into the interior as second branched light, the incident surface transmits the first branched light entering from the branching surface via the first optical system into the interior, the output surface outputs the second branched light reaching from the branching surface through the interior to the outside, and the combining surface outputs the first branched light reaching from the incident surface through the interior to the outside, reflects the second branched light entering from the output surface via the second optical system, and combines the first branched light and the second branched light to be output to the outside as combined light. The first optical system reflects the first branched light output from the branching surface by one or a plurality of mirrors, and directs the light to the incident surface. The second optical system reflects the second branched light output from the output surface by one or a plurality of mirrors, and directs the light to the combining surface. The drive unit moves any of the mirrors of the first optical system or the second optical system to adjust a difference between optical path lengths of the first branched light and the second branched light from the branching surface to the combining surface. Further, in the optical interferometer of the above-described embodiment, the total number of the mirrors in the first optical system and the mirrors in the second optical system is an even number, and the optical interferometer branches a light ray at each position in a beam cross-section of the incident light on the branching surface, and then combines the light rays at a common position in a beam cross-section of the combined light on the combining surface.

Preferably, in the optical interferometer of the above-described configuration, the first branched light and the second branched light have the same optical path length in the branching-combining unit. Further, preferably, in the optical interferometer, the branching surface and the output surface of the branching-combining unit are parallel to each other. Further, preferably, in the optical interferometer, the incident surface and the combining surface of the branching-combining unit are parallel to each other.

Preferably, in the optical interferometer of the above-described configuration, the branching surface and the incident surface of the branching-combining unit are parallel to each other. Further, preferably, in the optical interferometer, the branching surface and the incident surface of the branching-combining unit are on a common plane. Further, preferably, in the optical interferometer, an incident region of the incident light on the branching surface and an incident region of the first combined light on the incident surface of the branching-combining unit coincide with each other.

Preferably, in the optical interferometer of the above-described configuration, the output surface and the combining surface of the branching-combining unit are parallel to each other. Further, preferably, in the optical interferometer, the output surface and the combining surface of the branching-combining unit are on a common plane. Further, preferably, in the optical interferometer, an output region of the second branched light on the output surface and an output region of the combined light on the combining surface of the branching-combining unit coincide with each other.

The optical interferometer of the above-described configuration may further include a detection unit for detecting the combined light output from the combining surface of the branching-combining unit to the outside.

### INDUSTRIAL APPLICABILITY

The present invention can be used as a MEMS-based optical interferometer capable of decreasing the light loss from branching to combining and improving the interference efficiency.

### REFERENCE SIGNS LIST

1A-1F—optical interferometer, 10—branching-combining unit, 11—branching surface, 12—incident surface, 13—output surface, 14—combining surface, 20—first optical system, 21-23—mirror, 30—second optical system, 31-33—mirror, 40—drive unit, 50—detection unit, 90—dispersion compensating member, L₀—incident light, L₁₁, L₁₂—first branched light, L₂₁, L2₂—second branched light, L₃—combined light.

1. An optical interferometer comprising a branching-combining unit; a first optical system; a second optical system; and a drive unit, which are MEMS-based components, wherein
the branching-combining unit includes a branching surface, an incident surface, an output surface, and a combining surface on an interface between the interior and the exterior of a transparent member,
the branching surface and the combining surface are provided separately,
the branching surface partially reflects incident light entering from the outside and outputs as first branched light, and transmits the rest of the incident light into the interior as second branched light,
the incident surface transmits the first branched light entering from the branching surface via the first optical system into the interior,
the output surface outputs the second branched light reaching from the branching surface through the interior to the outside,
the combining surface outputs the first branched light reaching from the incident surface through the interior to the outside, reflects the second branched light entering from the output surface via the second optical system, and combines the first branched light and the second branched light to be output to the outside as combined light, and
the first optical system is configured to reflect the first branched light output from the branching surface by one or a plurality of mirrors, and direct the light to the incident surface,
the second optical system is configured to reflect the second branched light output from the output surface by one or a plurality of mirrors, and direct the light to the combining surface,
the drive unit is configured to move any of the mirrors of the first optical system or the second optical system to adjust an optical path difference between the first branched light and the second branched light from the branching surface to the combining surface,
the total number of the mirrors in the first optical system and the mirrors in the second optical system is an even number, and
the optical interferometer is configured to branch a light ray at each position in a beam cross-section of the incident light on the branching surface, and then combine the light rays at a common position in a beam cross-section of the combined light on the combining surface.

2. The optical interferometer according to claim 1, wherein the first branched light and the second branched light have the same optical path length in the branching-combining unit.

3. The optical interferometer according to claim 1, wherein the branching surface and the output surface of the branching-combining unit are parallel to each other.

4. The optical interferometer according to claim 1, wherein the incident surface and the combining surface of the branching-combining unit are parallel to each other.

5. The optical interferometer according to claim 1, wherein the branching surface and the incident surface of the branching-combining unit are parallel to each other.

6. The optical interferometer according to claim 5, wherein the branching surface and the incident surface of the branching-combining unit are on a common plane.

7. The optical interferometer according to claim 6, wherein an incident region of the incident light on the branching surface and an incident region of the first branched light on the incident surface of the branching-combining unit coincide with each other.

8. The optical interferometer according to claim 1, wherein the output surface and the combining surface of the branching-combining unit are parallel to each other.

9. The optical interferometer according to claim 8, wherein the output surface and the combining surface of the branching-combining unit are on a common plane.

10. The optical interferometer according to claim 9, wherein an output region of the second branched light on the output surface and an output region of the combined light on the combining surface of the branching-combining unit coincide with each other.

11. The optical interferometer according to claim 1, further comprising a detection unit detecting configured to detect the combined light output from the combining surface of the branching-combining unit to the outside.
